(19) United States
(12) Patent Application Publication
(10) Pub. No.: US 2026/0087572 A1
(43) Pub. Date: Mar. 26, 2026

(54) EVALUATION BOTS FOR NEW INVENTIONS

(71) Applicant: International Business Machines Corporation, Armonk, NY (US)

(72) Inventors: Jun Su, Beijing (CN); Yang Liang, Beijing (CN); Su Liu, Austin, TX (US); Karen Beale, Mitchellville, MD (US); Fan Yang, Beijing (CN)

(21) Appl. No.: 18/896,501

(22) Filed: Sep. 25, 2024

(51) Int. Cl. G06Q 50/18

(52) U.S. Cl. CPC G06Q 50/184

(57) ABSTRACT

A method, according to one embodiment, includes causing a plurality of evaluation bots to evaluate information about a first new invention, where the evaluation bots are configured to identify and exclude sub-portions of the information during the evaluations. The sub-portions of the information are based on human opinion. The method further includes using an output of the evaluation bots to calculate scores for factors identified during the evaluations of the information about the first new invention. The method further includes determining, based on the calculated scores, a total novelty score for the first new invention, and correlating the total novelty score to a suggested action, where the suggested action corresponds to a course of action to follow with respect to securing intellectual property rights of the first new invention. The suggested action is displayed on a display of a user device.

### BACKGROUND

The present invention relates to inventions, and more specifically, this invention relates to new invention disclosures.

Innovation is a driving force for economic growth, technological advancement, and societal progress. Inventions are protected in different countries by different intellectual property governing entities, such as a patent office. The patent system plays a crucial role in incentivizing and protecting innovations by granting inventors exclusive rights to their creations for a period of time.

### SUMMARY

A method, according to one embodiment, includes causing a plurality of evaluation bots to evaluate information about a first new invention, where the evaluation bots are configured to identify and exclude sub-portions of the information during the evaluations. The sub-portions of the information are based on human opinion. The method further includes using an output of the evaluation bots to calculate scores for factors identified during the evaluations of the information about the first new invention. The method further includes determining, based on the calculated scores, a total novelty score for the first new invention, and correlating the total novelty score to a suggested action, where the suggested action corresponds to a course of action to follow with respect to securing intellectual property rights of the first new invention. The suggested action is displayed on a display of a user device.

A computer program product, according to another embodiment, includes one or more computer-readable storage media, and program instructions stored on the one or more storage media to perform the foregoing method.

A computer system, according to another embodiment, includes a processor set, one or more computer-readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3A is a structure, in accordance with one embodiment of the present invention.

FIG. 3B is a structure, in accordance with one embodiment of the present invention.

FIG. 4 is a diagram of a system, in accordance with one embodiment of the present invention.

FIG. 5 is a table, in accordance with one embodiment of the present invention.

FIG. 6 is an architecture, in accordance with one embodiment of the present invention.

FIG. 7A is an evaluation report, in accordance with one embodiment of the present invention.

FIG. 7B is an evaluation report, in accordance with one embodiment of the present invention.

FIG. 7C is an evaluation report, in accordance with one embodiment of the present invention.

FIG. 7D is an evaluation report, in accordance with one embodiment of the present invention.

FIG. 8 is a table, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for training and using evaluation bots for evaluating new inventions.

In one general embodiment, a method includes causing a plurality of evaluation bots to evaluate information about a first new invention, where the evaluation bots are configured to identify and exclude sub-portions of the information during the evaluations. The sub-portions of the information are based on human opinion. The method further includes using an output of the evaluation bots to calculate scores for factors identified during the evaluations of the information about the first new invention. The method further includes determining, based on the calculated scores, a total novelty score for the first new invention, and correlating the total novelty score to a suggested action, where the suggested action corresponds to a course of action to follow with respect to securing intellectual property rights of the first new invention. The suggested action is displayed on a display of a user device.

In another general embodiment, a computer program product includes one or more computer-readable storage media, and program instructions stored on the one or more storage media to perform the foregoing method.

In another general embodiment, a computer system includes a processor set, one or more computer-readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as evaluation bot training and deployment code of block 150 for training and using evaluation bots for evaluating new inventions. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

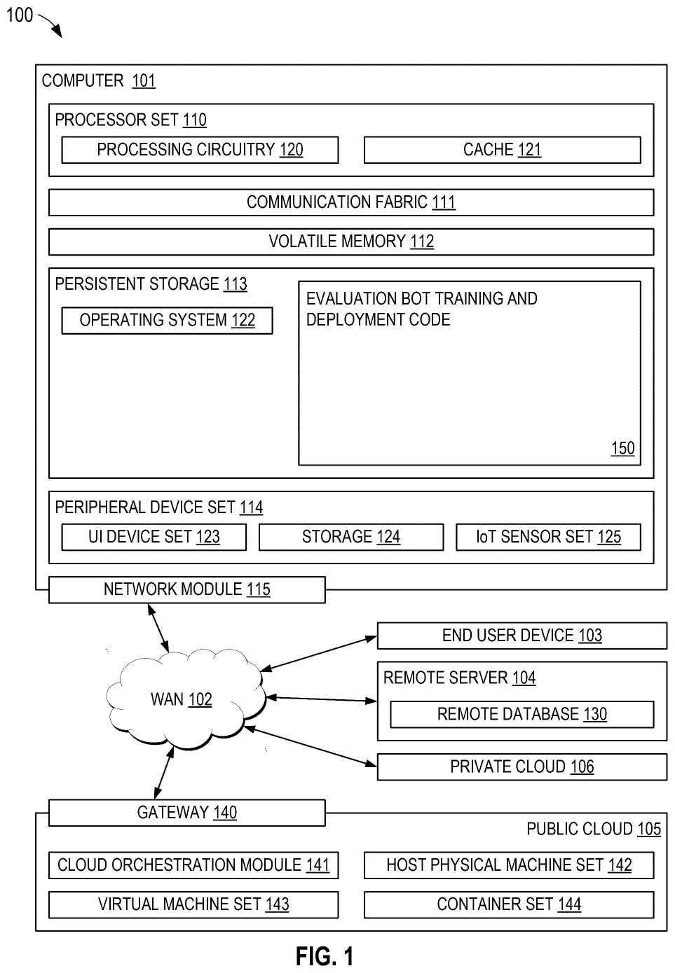

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, innovation is a driving force for economic growth, technological advancement, and societal progress. Inventions are protected in different countries by different intellectual property governing entities, such as a patent office. The patent system plays a crucial role in incentivizing and protecting innovations by granting inventors exclusive rights to their creations for a period of time.

Conventional patent and innovation review processes face challenges related to subjectivity, biases, and efficiency. For example, humans of a corporation cannot be relied on to efficiently determine the potential patent scope of an invention developed within the corporation, because such humans subliminally incorporate bias into their determinations. For example, each reviewer's unique experience within the corporation undoubtedly contributes to a determination that includes at least some degree of bias. This is inefficient because the determined potential patent scope of an invention becomes inaccurate as a result of these biases.

The current landscape of patent evaluation is marked by several challenges and pain points, and therefore a longstanding need for a transformative approach exists. These challenges impact the efficiency, objectivity, and adaptability of the patent review process, hindering its ability to keep pace with the dynamic nature of technological advancements. Key challenges and pain points, in some deployments, include subjectivity and bias. Biases in evaluation can lead to inconsistencies, potentially resulting in the overlooking of innovative contributions and impacting the fairness of the patent review. As briefly noted elsewhere above, human evaluators, despite their expertise, can introduce unintentional biases and subjective judgments into the patent evaluation process. These biases may be influenced by personal experiences, cultural factors, or individual perspectives.

These key challenges and pain points, in some deployments, additionally include manual and time-consuming processes. Some traditional patent evaluation procedures rely heavily on manual processes, requiring evaluators to read through extensive patent disclosures and conduct time-consuming prior art searches. The manual nature of these tasks not only delays the overall patent application process but also limits the scalability and efficiency of evaluations, especially in the face of a growing volume of patent applications. These procedures furthermore have limited adaptability to industry trends. The static nature of current evaluation criteria crate challenges with respect to adaptability to emerging industry trends, new keywords, and evolving patterns in technological innovations. Accordingly, conventional evaluations fail to capture the most recent and relevant prior art, leading to an incomplete understanding of the state-of-the-art and potentially impacting the accuracy of assessments.

Conventional procedures are also call for relatively resource intensive processing. For example, searching for prior art across vast patent databases, technical discussion forums, and scientific journals is a resource-intensive process, demanding significant time and effort from evaluators. The sheer volume of data poses a risk of information overload, making it difficult for evaluators to comprehensively review all relevant materials, potentially resulting in oversight and incomplete assessments.

There is also a risk of inconsistency that arise in evaluations due to variations in expertise among human evaluators. The lack of standardized criteria and the subjective nature of assessments contribute to disparities in determining the novelty and inventive step of inventions. Inconsistent evaluations undermine the reliability and credibility of the patent review process, affecting the fairness and objectivity of decisions. The technical field of intellectual property also experiences limited collaboration between artificial intelligence (AI) and human experts, which proves the non-obviousness of the techniques described herein. More specifically, while AI models are increasingly used in patent evaluation, there is often a lack of effective collaboration between AI systems and human experts. Existing models do not fully leverage human evaluators'insights for continuous improvement. The absence of a collaborative framework inhibits the harnessing of the collective intelligence of both AI and human experts, limiting the adaptability and learning capacity of the evaluation system.

In sharp contrast to the deficiencies described above, the techniques of embodiments and approaches described herein develop and deploy bots, which may be also referred to herein as “bias-free innovation assessment bots (BFIA-bots)” that, in some approaches, function with human-computer interaction (HCI)-driven adaptation of AI Criteria in novelty screening for ensuring objective evaluations free from unintentional human biases, enhancing efficiency and accuracy on disclosure evaluation and screen, and increasing an adaptability to new scientific, technological, and business trends. This development and deployment improves the technical field of evaluations within intellectual property by addressing the need to enhance the overall patent evaluation landscape.

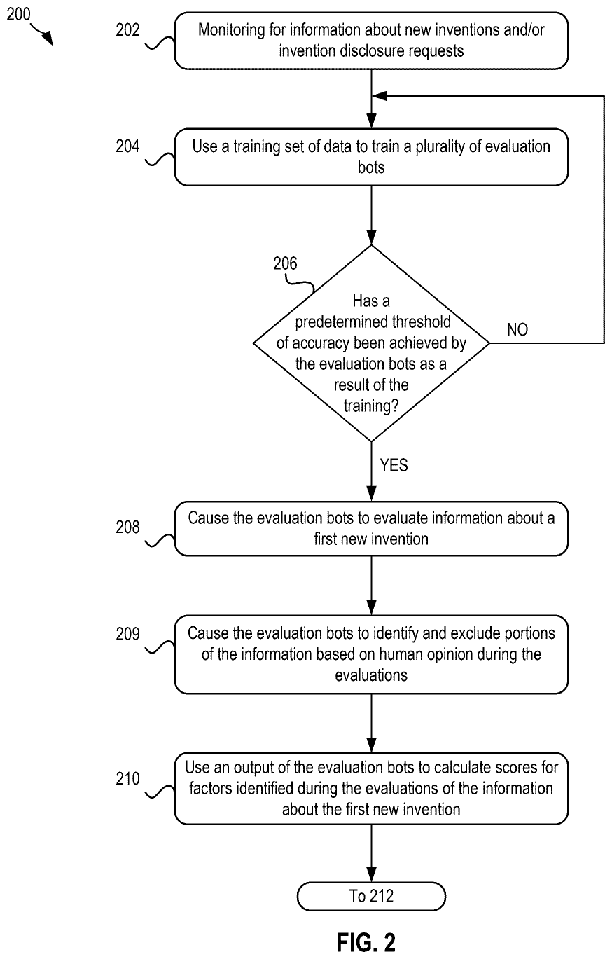

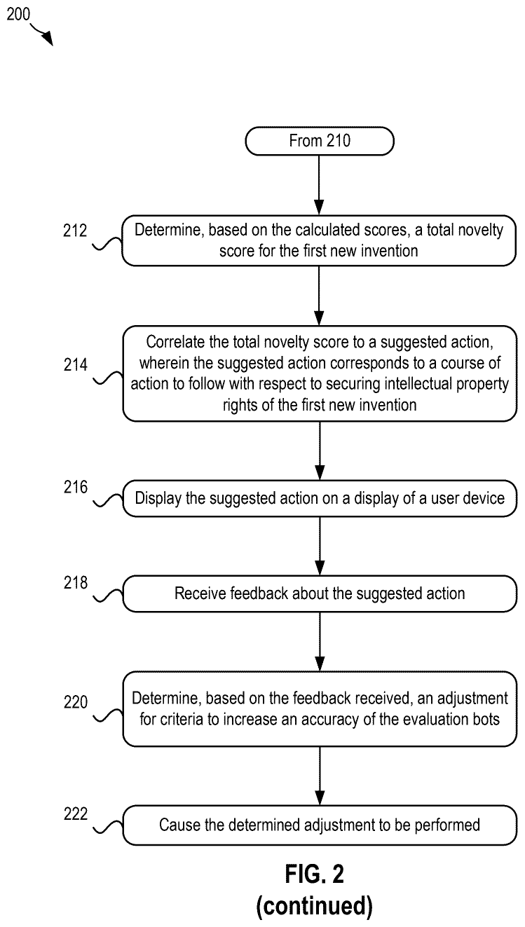

Now referring to FIG. 2, a flowchart of a method 200 is shown according to one embodiment. The method 200 may be performed in accordance with aspects of the present invention in any of the environments depicted in FIGS. 1-8, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 of method 200 includes monitoring for information about new inventions and/or invention disclosure requests, e.g., invention disclosure packets, figures associated with a new invention, surprising results obtained while developing a new invention, costs associated developing a new invention, etc. The monitoring may, in some approaches, be performed by a bot that is trained to monitor information and/or communication threads and/or data repositories for predetermined types of information. For example, in one use case, a bot may be trained under the direction of a company to monitor data stored on a server of the company for predetermined types of information. In some approaches, the bot may be referred to herein as a BFIA bot monitor that is trained to perform monitoring and identification techniques that would become apparent to one of ordinary skill in the art after reading the descriptions herein to identify predetermined types of information. In some approaches, such a bot may monitor folders of a server that new invention disclosure packets are stored in. In some other approaches, such a bot may identify information about a new invention, e.g., information about a first new invention, from an internal electronic discussion forum of a company, e.g., based on predetermined keyword triggers.

In some approaches, method 200 includes training one or more bots to evaluate information that is being monitored for, e.g., information about new invention(s). In some approaches, in order to develop specifications that are used to train the bots and/or that are deployed by the bots, method 200 includes determining service settings for the evaluation bots to apply to evaluate the information about the first new invention. The service settings may, in some approaches, include permissible search engines that the evaluation bots are permitted to use to evaluate the information about the a new invention, review discussion boards and/or channels (of an invention disclosure team (IDT)) that the evaluation bots are permitted to use to evaluate the information about a new invention, evaluator academic histories (of evaluators that generated at least some of the information about the first new invention) that the evaluation bots are permitted to consider to evaluate the information about the first new invention, etc. In some other approaches, the service settings may additionally and/or alternatively include predetermined patent resources, where such resources detail processing and/or computational thresholds that the bots are not to exceed while performing such evaluations. In some other approaches, the service settings may additionally and/or alternatively include enable and/or disable services, which may specify when the bots are perform such evaluations (such as a period of time in which at least a predetermined number of processing resources are available) and/or when the bots are to suspend evaluations (such as a period of time in a disaster event is detected and/or a failover sequence has been initiated within a system that includes infrastructure that the bots are executed on).

In some approaches, in order to develop specifications that are used to train the bots and/or that are deployed by the bots, method 200 may additionally and/or alternatively include defining criteria for the evaluation bots to apply to evaluate the information about a new invention. According to various illustritive approaches, the criteria may include selected parameters and weights to scan the information about the first new invention with, a review board domain to use for obtaining the information about the first new invention, ranking rules for the evaluation bots to apply to evaluate the information about the first new invention, etc.

For context, the specifications detailed above (the service settings and/or criteria) may establish rules and operational principles that the evaluation bots operate according to. During training and deployment these specifications guide the evaluation bots, e.g., decisions and operations of the evaluation bots. For example, the plurality of evaluation bots may, during training and/or deployment, be caused, e.g., instructed, to evaluate information about a new invention. Note that descriptions here may refer more to the training context, while other descriptions herein further detail the deployment phase of the evaluation bots once they are trained, e.g., see operation 208.

During a training phase of the evaluation bots, the evaluation bots may be instructed to adhere to the service settings and the criteria while evaluating the information about a new invention. More specifically, this information about the new invention may be included in a training set of data. Accordingly, method 200 may include using a training set of data to learn how to train the evaluation bots, e.g., see operation 204. Initial training may include reward feedback that may, in some approaches, be implemented using a subject matter expert (SME) that generally understands answers to some of the training data based on having access to a history of how the inventions of the training set of data were used for business purposes, e.g., novel inventions (that produced lucrative income and experienced few prior art references during prosecution) versus non-novel inventions that did not produce lucrative income based on being abandoned during prosecution, relatively few licensing deals, being subjected to rejections based on a relatively extensive amount of prior art references during prosecution, etc.). However, to prevent costs associated with relying on manual actions of a SME, in another approach, reward feedback may be implemented using techniques for training a BERT model that the bots are incorporated into, as would become apparent to one skilled in the art after reading the present disclosure.

Using the training set of data to train the evaluation bots may, in some approaches, additionally and/or alternatively include accessing a management system to which information about new inventions is stored. Accordingly, the information about the first new invention may be obtained from the management system. A plurality of training samples may be collected from the information stored within the management system, where the plurality of training samples are vetted and aggregated to form the training set of data. Specific training operations may, in some approaches, include causing the evaluation bots to consume the training set of data and output novelty estimations for new inventions that the training set of data is based on (the first new invention and/or other new inventions that the information stored on the management system is based on) and determining an accuracy of the novelty estimations. In response to a determination that the determined accuracy exceeds a predetermined threshold of accuracy, reward based feedback is preferably provided to the evaluation bots to increase an accuracy of the evaluation bots over time.

Biases and/or other inefficiencies that human evaluators have previously incorporated into different previous evaluations of inventions based on being members of expertise groups may also be considered by the evaluation bots in the training data in order to prevent the biases and other inefficiencies from being included into evaluations that the evaluation bots participate in once trained. In some approaches, evaluator profiles, roles, jobs, titles, academic background (published papers, issued patents), etc., may be categorized by a BFIA categorizer for incorporating into the training set of data. The training set of data may also be transformed over time to reflect changes in the information that is monitored for and identified based on the monitoring. In order to obtain such data, method 200 optionally includes accessing innovation disclosure management systems and any disclosure data sources (e.g., pre-ranking and final ranking data in internal information systems of a corporation, internal discussion boards such as GITHUB, ZENHUB, SLACK channel, etc., review log, recorded internal disclosure review meetings, and real time meetings) to collect any useful HCI Data (keyword selection, prior art search, highlighted problems and claims, comparison tools access, etc.) as training samples related to invention disclosure reviewing events. These operations may, in some approaches, be performed by a data collector and transformation engine.

Transformation of the training data may additionally and/or alternatively, in some approaches, include identifying instances of subliminal bias within pass evaluations that involved human evaluators, e.g., analyzing evaluator behaviors and generating BFIA patterns (focused problem, technical trends, prior art search resource selection patterns on biological, computer science, or weather/environment disclosures) based on different evaluator expertise associated disclosure domains. In some approaches, the identification operations may be performed by a preconfigured BFIA analyzer component and/or a BFIA pattern repository component. At least some of the evaluation bots may be paired with assigned certain knowledges on certain domains to the human evaluators in the different categorized groups by a predetermined mapping component, to identify these subliminal biases that human evaluators were not able to identify and exclude in previous evaluations. These paired evaluation bots are thereafter trained using the paired patterns to provide scores based on analysis performed for the previously evaluated inventions, and verification steps are performed to ensure that the evaluations performed by the evaluation bots during training do not include such biases.

In some approaches, at least one of the evaluation bots, e.g., a first of the evaluation bots, is trained to identify information based on human opinion. More specifically, at least one of the evaluation bots may be trained to identify a sub-portion of the information that is based on human opinion and/or bias. Such sub-portions of the information may be identified based on the evaluation bots being trained to scan the information to identify predetermined keywords associated with human opinion and/or bias. The evaluation bots may be trained to exclude these sub-portions of the information from consideration in order to refine contents of the information that are processed, which thereby reduces an extent of computer processing operations that are performed.

Data structures may, in some approaches, be developed. Such data structures may be used for refining the training data and/or used as context in determinations performed by the trained evaluation bots, such as during evaluation of a new invention.

To define such data structures, in some approaches, method 200 includes defining a bot data structure with related algorithms for tracking information about a plurality of new inventions over time. Note that the plurality of new inventions may include the first new invention mentioned in approaches herein. In some approaches, the information added to these structures may include keyword selections, prior art searches, highlighted problems and claims, comparison tools accessed, etc.) in different predetermined associated classes. Furthermore, in some approaches, the information added to such a structure may include evaluation bot data which may include one or more of, e.g., identifiers (IDs) of the evaluation bots, evaluator bot pairings, domain IDs, disclosure IDs, determined scores (such as the types of scores mentioned in operations elsewhere herein, etc.

Method 200 may additionally and/or alternatively include defining an installable plugin and/or stand-alone application that is configured to collaborate with an innovation review graphical user interface (GUI) and a predetermined innovation management system that serves as an extension for the evaluation bots (a BFIA-Extension). Information observed via this collaboration may be stored in the data structure described above.

A determination may be made as to whether a predetermined threshold of accuracy has been achieved by the evaluation bots as a result of the training, e.g., see decision 206. Techniques for determining an accuracy of bots during AI training that would become apparent to one of ordinary skill in the art after reading the descriptions herein may be used to determine whether the predetermined threshold of accuracy has been achieved. It should be noted that the predetermined threshold may, in some approaches, be dynamically adjusted at any time, e.g., in response to a determination that the bots make an incorrect assessment of an invention, in response to a determination that negative feedback has been received regarding determinations made using the trained bots, etc.

In response to a determination that the predetermined threshold of accuracy has not been achieved by the evaluation bots, e.g., as illustrated by the “NO” logical path of decision 206, training of the bots optionally continues. In contrast, in response to a determination that the predetermined threshold of accuracy has been achieved by the evaluation bots, e.g., as illustrated by the “YES” logical path of decision 206, method 200 optionally continues to operation 208.

Operation 208 includes causing the trained evaluation bots to evaluate the information about the first new invention (identified during the monitoring) in response to a determination that a predetermined threshold of accuracy has been achieved by the evaluation bots as a result of the training. It should be noted that although various approaches described herein detail that a plurality of evaluation bots are trained and used to evaluate information about new inventions, e.g., [B1, B2, B3, Bi, Bn], in some other approaches, a single evaluation bot may be trained and/or used to perform such evaluations. In some approaches, the evaluation bots are caused to evaluate the information about the first new invention based on an instruction being issued to a BFIA task assigner component, which may be a controller that is configured to control the evaluation bots.

In some preferred approaches, causing the plurality of evaluation bots to evaluate information about the first new invention includes instructing the evaluation bots to scan the information about the first new invention for identifying predetermined factors. More specifically, in some approaches, the information is scanned to determine whether the predetermined factors are present in the information. In some other approaches, the information is scanned to identify and collect information associated with the predetermined factors. The factors, according to some approaches, include a focused problem (e.g., a problem in conventional technical fields that the first new invention attempts to address), listed alternative methods for achieving an outcome of the first new invention, a discoverability of the first new invention (whether the invention is an obvious variant of existing technologies, whether the invention could be preserved as a trade secret, etc.), technical contributions of the first new invention (research and development used to develop the invention, technical effects that the invention provide, etc.), a business value of the first new invention (expected licensing revenues provided that a patent is obtained for the first new invention, an annual revenue of a field of a corporation that the first new invention is based on, an estimated sale of a patent provided that a patent is obtained for the first new invention, design-around potential for competitors of the first new invention, etc.), a license value of the first new invention (such as a number of companies that would potentially license a patent for the first invention), etc.

In some preferred approaches, at least one of the evaluation bots is caused (e.g., instructed, trained, etc.) to identify information based on human opinion, and to exclude the identified information in the evaluation of the information about the first new invention, e.g., see operation 209. In one approach, the bot may be pretrained to identify and/or exclude such information, and operation 209 may include activating this feature. In another approach, the bot may be trained to identify and/or exclude this information upon use thereof.

Sub-portions of the information deemed to be based on human opinion may, in some approaches, include text strings that are input into a user device to incorporate input into an evaluation of the first new invention. This information may additionally and/or alternatively include, e.g., expressed opinions regarding the novelty of the first new invention, implied opinions regarding the novelty of the first new invention, statements that may be interpreted as intentional bias, statements that may be interpreted as unintentional bias, etc. The trained evaluation bots preferably exclude these sub-portions of the information from consideration during the evaluation of the information about the first new invention for a number of reasons. First of all, this exclusion prevents the evaluation from being compromised by human judgement, which is (intended or not) prone to bias. Human intervention cannot be used to look for such biases (as to otherwise allow for removal of such biases from the evaluation) because the presence of some bias is unrecognizable to at least some users that (knowing or unknowingly) agree with the bias. Furthermore, this exclusion from the evaluation reduces a computational workload of the evaluator bots, thereby streamlining an output of the evaluation bots, preserving processing resources, and relatively reducing network traffic of a network that the evaluation bots communicate within.

An output of the evaluation bots may be used to calculate scores for factors identified during the evaluations of the information about the first new invention, e.g., see operation 210. Based on the illustritive examples provided above, a plurality of scores may be calculated, e.g., ProblemScore, AlternativeScore, DiscoverabilityScore, TechnicalContributionScore, BusinessScore, LicenseScore. In some approaches, these scores may be calculated as proportional values to the amounts of information about the factors that is identified within the information about the first new invention. In such approaches, the output of the evaluation bots includes information that details the different amount of information about the factors, e.g., heat maps. In some other approaches, these scores may additionally and/or alternatively be calculated by applying a predetermined penalty to factors determined to include human opinions (in associated sub-portions of the information). In yet another approach, scoring calculation techniques may use AI correlation techniques of a type that would become apparent to one of ordinary skill in the art after reading the descriptions herein to correlate portions of the information with existing patents. Based on these correlation, forecasting techniques of a type that would become apparent to one of ordinary skill in the art after reading the descriptions herein may be used to determined forecasted outcomes for the first invention (with respect to the different factors). These outcomes may be scores based on their favorability, e.g., relatively less desirable and profitable outcomes may be assigned relatively lower scores while relatively more desirable and profitable outcomes may be assigned relatively higher scores. In some other approaches, the output of the evaluation bots are the calculated scores, which may be calculated using one or more of the techniques mentioned above.

With continued reference to operation 210, in some approaches, in a predetermined scoring system used herein, higher scores indicate higher novelty, as each point may be assigned based on the presence of certain features or characteristics that contribute to the novelty of the invention being evaluated. For example, in the context of the scoring system, a relatively higher novelty score suggests that the invention is perceived as having more novel features and characteristics based on the assigned points for each criterion. In contrast, a relatively lower score suggests relatively less novelty, as fewer points are assigned for characteristics that contribute to the overall novelty of the invention. In some approaches, predetermined adjustments may be made to weights applied to the scores. In some approaches, these adjustments are based on percentages specified in a request received from a user device used by an administrator.

One illustritive example based on this scoring may be based on a company (Company A) that has identified a problem in its core business related to manufacturing inefficiencies in a specific product line. A problem score based on this problem (ProblemScore) may be assigned two points, while an alternative score (AlternativeScore) based on alternatives to a new invention to solve this problem may be assigned one point based on the evaluation bots detailing that the evaluated new invention provides a relatively more cost-effective solution compared to existing alternatives. A discoverability score (DiscoverabilityScore) based on this invention may be based on information provided by the evaluation bots detailing that the use of the new invention can be relatively easily detected by examining the product's operation. This information may be used to calculate four points for the discoverability score. A technical contribution score (TechnicalContributionScore) of three points may be calculated based on information that details that the invention represents a significant addition to known technology. Furthermore, a business score (BusinessScore) of two points may be based on information that is identified by the bots that indicates that the new invention is intended for both internal and external use by Company A. A license score that is based on use by others (LicenseScore) may be calculated as five points and be based on information that details that the new invention is expected to have wide use in products and services across multiple industry sectors.

Operation 212 includes determining, based on the calculated scores, a total novelty score for the first new invention. For context, the total novelty score reflects an overall novelty (with respect to the different factors) of the new invention being evaluated. Note that the “total novelty score” is also referred to herein as a “total innovation score (TIS)” in some approaches, e.g., see FIG. XX. Total novelty scores may be calculated based on different predetermined formulas for aggregating the different scores. These predetermined formulas may, in some approaches, include different averaging formulas, different weighting formulas, etc. For example, in the example above, the total novelty score may be a sum of the different determined scores, e.g., adding up the points: 2+1+4+3+2+5=17. However, this is just an example, and in other approaches, a different predetermined calculation technique may be used.

Operation 214 includes correlating the total novelty score to a suggested action, which may be a particular action selected from a group of possible actions. For context, the suggested action may correspond to a particular course of action to follow with respect to securing intellectual property rights of the first new invention. Details such as the steps to take when following the course of action, how to perform such steps, etc. may be output, e.g., to a computer, to a user, etc. In some approaches, the suggested action includes searching for prior art and/or writing a patent application for the first new invention according to a first predetermined set of guidelines (may also be referred to herein as “Rating1”), while in some other approaches, the suggested action includes searching for prior art and/or writing a patent application for the first new invention according to a second predetermined set of guidelines (may also be referred to herein as “Rating2”) or searching for prior art and/or writing a patent application for the first new invention according to a third predetermined set of guidelines (may also be referred to herein as “Rating3”). The different predetermined set of guidelines may, in some approaches, detail different search conditions to apply while searching for the prior art and/or different amounts of descriptive detail to add to an application writeup while writing the patent application for the first new invention. For example, the first predetermined set of guidelines may call for a relatively stricter search and/or relatively more descriptive detail than the second and third predetermined set of guidelines, while the second predetermined set of guidelines may call for a relatively stricter search and/or relatively more descriptive detail than the third predetermined set of guidelines. In some approaches, the suggested action includes publishing a public article about the first new invention and not filing a patent application for the first new invention. Such a suggested action may be correlated with a total novelty score within a predetermined range that is pre-associated with cases in which the cost of attempting to secure intellectual property rights on a new invention is estimated to outweigh the estimated return value of a patent being secured on the new invention, e.g., such as where a technical field of the new invention is determined to have a relatively extensive amount of prior art. In some other approaches, the suggested action includes discarding the first new invention (may also be referred to as “closing” the new invention), e.g., not expending further resources on the new invention based on a technical field of the new invention is determined to have a relatively extensive amount of prior art, in response to a determination that the new invention can be secured as a trade secret, etc.

It should be noted that, in some preferred approaches, relatively greater total novelty scores may be correlated with suggested actions that include a relatively greatest expenditure of resources and processing operations in an attempt to secure a patent on the new invention, while relatively lesser total novelty scores may be correlated with suggested actions that include a relatively lowest amount of expended resources and processing operations in an attempt to preserve intellectual property resources and processing operations from being wasted on a new invention determined to have limited to no novelty.

Operation 216 includes displaying the suggested action on a display of a user device. In some approaches, an indication of the suggested action may be output from a processing circuit performing method 200 to a display device for causing the suggested action to be displayed. In some approaches, the total novelty score may additionally and/or alternatively be returned to a user device from which a request was received to evaluate the first new invention.

In order to further refine an accuracy of the techniques described herein, and more specifically, refine an accuracy of the evaluation bots, some approaches include receiving feedback about the suggested action, e.g., see operation 218. IN some approaches in which the suggested action includes writing and filing a patent application for the first new invention, the feedback may detail an estimated revenue generated licensing and/or selling a patent granted based on filing the patent application for the first new invention. Operation 220 includes determining, based on the feedback received, an adjustment for the criteria to increase an accuracy of the evaluation bots. According to some approaches, these adjustments may include, e.g., increasing threshold(s) of accuracy in response to a determination that the feedback received is negative feedback. The evaluation bots may be retrained to update an accuracy of the evaluation bots in response to a determination that the threshold(s) of accuracy have been increased.

Operation 222 includes causing the adjustments to be made to the criteria. As indicated above, retraining of the evaluation bots may be initiated in response to such adjustments being made.

Various performance benefits are enabled within the technical field of intellectual property evaluations by deploying the techniques described herein. For example, these techniques enable objective and unbiased evaluations which is not possible to achieve manually. To enable this, the evaluation bots (BFIA bots) mitigate biases by incorporating HCI-driven adaptation, ensuring objective evaluations free from unintentional, and oftentimes subliminal, human biases. These techniques furthermore enable efficiencies and time saving evaluation techniques. This is enabled via automation of manual processes, including prior art searches and text summarization, which enhances efficiency and significantly reduces the time required for innovation evaluations. Dynamic adaptability to trends is also enabled as the techniques described herein offer real-time adaptation to emerging industry trends and keywords which ensures that the evaluation criteria remain aligned with the ever-evolving technological landscape. Collaborative AI-human interactions are also enabled as the evaluation bots foster optional collaboration between AI and human experts, leveraging the collective intelligence for continuous improvement and a more nuanced evaluation process. Bias detection and mitigation are also enabled as advanced algorithms are employed to actively detect and mitigate biases in innovation evaluations. This enhances the fairness and reliability of the assessment process of a new invention. A user-friendly interface and feedback loop is furthermore enabled, which includes a user-friendly interface that allows for easy interaction, input of innovation disclosures, and viewing of assessment results. The feedback loop facilitates continuous improvement and user-centric innovation assessment. Risk mitigation and consistency is also provided by automating certain tasks and introducing standardized criteria. As a result, the evaluation bots mitigate the risk of inconsistencies in evaluations, contributing to more reliable and consistent innovation reviews. Thoroughness in prior art searches are also enabled as the evaluation bots optimize prior art searches by identifying relevant keywords and patterns from HCI analysis. This ensures evaluators have prompt access to the pertinent information. Real-time innovation assessments are also enabled in the form of real-time adaptation to industry trends and continuous learning/training mechanisms that enable the evaluation bots to provide up-to-date and relevant assessments. This enables evaluations to keep pace with rapid technological advancements without delay.

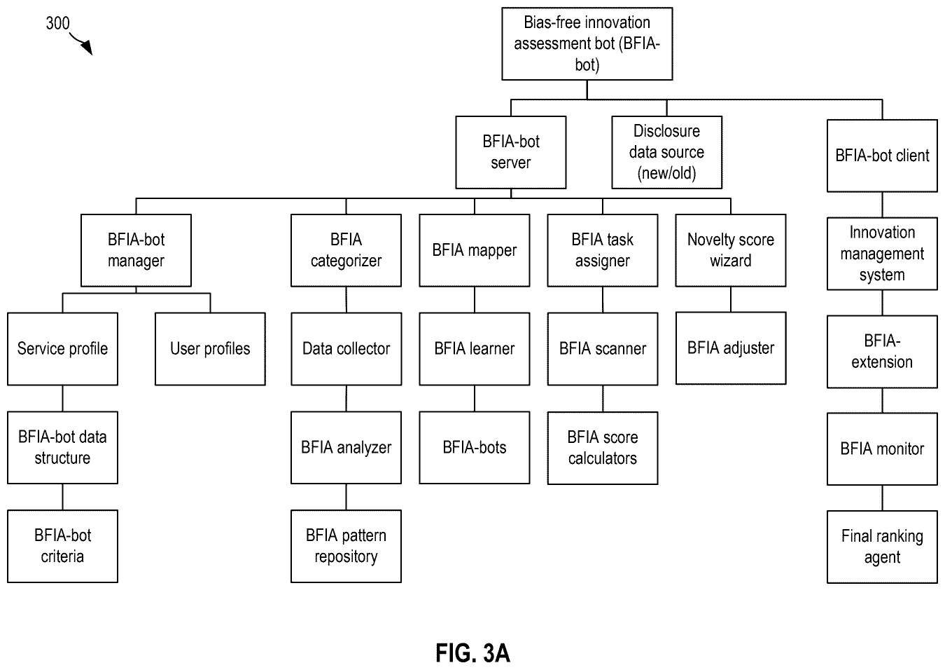

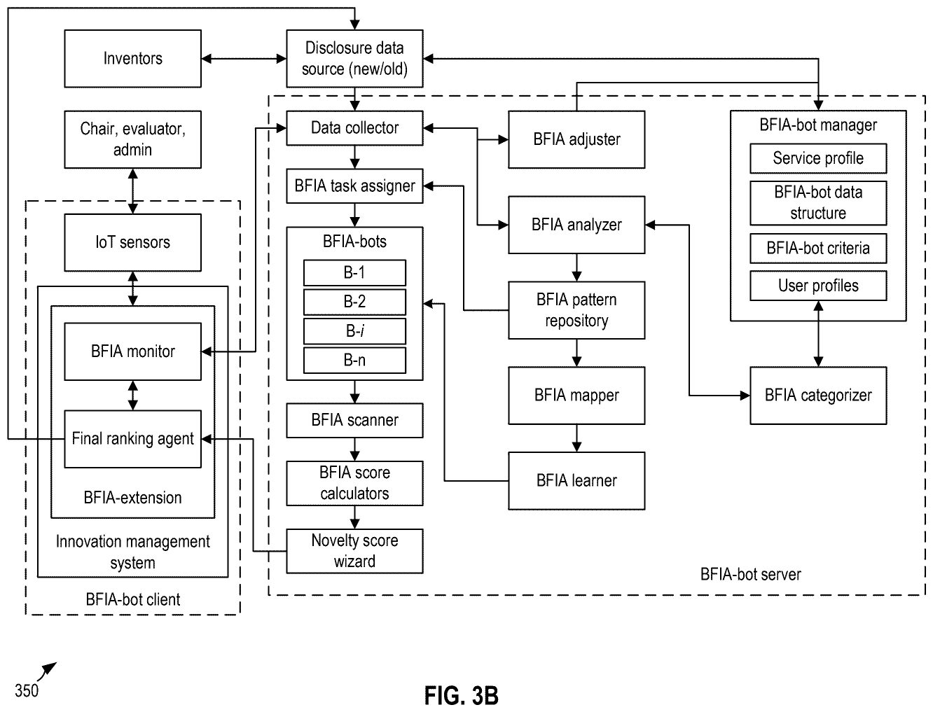

FIGS. 3A and 3B depict structures 300 and 350, in accordance with several embodiments. As an option, the present structures 300 and 350 may be implemented in conjunction with features from any other embodiment listed herein, such as those described with reference to the other FIGS. Of course, however, such structures 300 and 350 and others presented herein may be used in various applications and/or in permutations which may or may not be specifically described in the illustrative embodiments listed herein. Further, the structures 300 and 350 presented herein may be used in any desired environment.

For context, the structure 300 depicts infrastructure components of an evaluation bot, e.g., a BFIA bot, while the structure 350 depicts infrastructure of an environment in which evaluation bots may be deployed to evaluate new inventions.

Referring now to the structure 300, the BFIA bot may interact with and/or have resources that include a server, e.g., see BFIA-bot server, an invention data source of new and past inventions, e.g., see Disclosure data source (new/old), and a client interaction infrastructure on which invention evaluation requests may be received, e.g., see BFIA-bot client.

In some approaches, the BFIA-bot server includes a manager component and/or resources, e.g., see BFIA-bot manager. The manager component may be configured to store and/or adjust service profile information, user profiles associated with new inventions, data structures defined by the evaluation bot, e.g., see BFIA-bot data structure, and criteria, e.g., see BFIA-bot criteria.

A categorizer for evaluator profiles, e.g., see BFIA categorizer, may, depending on the approach, operate with a data collector, an analyzer and pattern repository resources, e.g., see BFIA analyzer and BFIA pattern repository. Furthermore, mapping resources, a leaning components and further bots may be used to train evaluation bots and/or generate feedback that is used to ongoingly identify and exclude biases from invention evaluations.

Assigner, scanner and calculator components are resources of the evaluation bot that are trained and used to evaluate a new invention to determine a suggested action. These resources may additionally and/or alternatively include a score wizard and adjuster configured to perform one or more of the calculations and updates described herein.

In some approaches, in order to fulfill requests from a client, the evaluation bot may interact with a management system and/or an extension that facilitates communication between the evaluation bot(s) and a user device of a client, e.g., see BFIA-extension. This way, monitoring may be performed for new inventions, e.g., see BFIA monitor. A final ranking agent is also included in structure 300 for determining a total novelty score using the techniques described herein.

Referring now to FIG. 3B, various portions of the structure 300 of FIG. 3A are shown in the structure 350. For example, the BFIA-bot server is shown obtaining information about new inventions that are generated by inventors, e.g., see output of Disclosure data source (new/old). Furthermore, IoT sensors are shown collecting such information, which may include information obtained from administrators, company department chairs, evaluators, etc. In some approaches, the tasks associated with evaluating a new invention may be divided among a plurality of bots, e.g., see BFIA task assigner output to BFIA-bots, in order to streamline throughput of determinations of the evaluation.

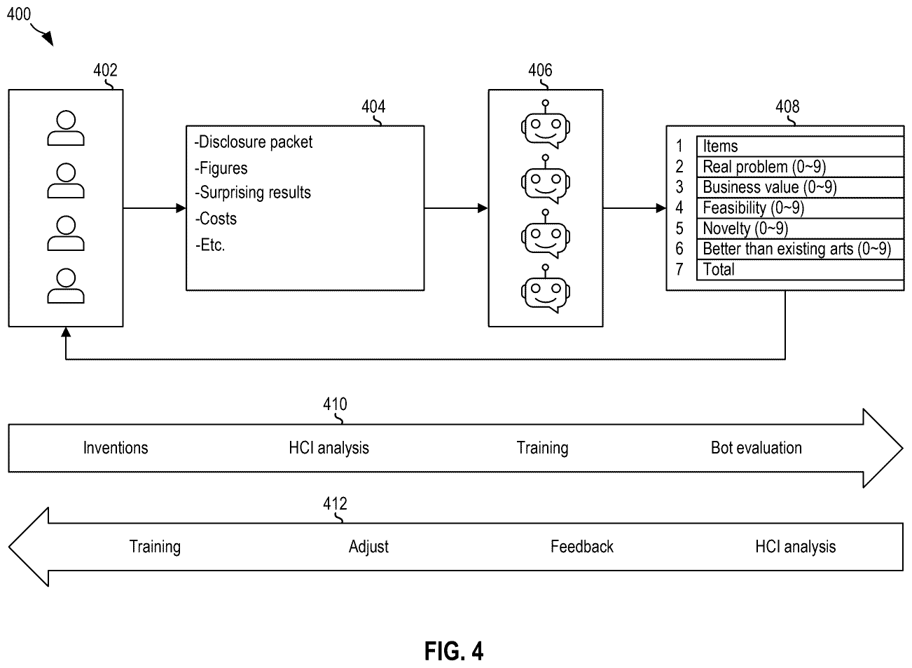

FIG. 4 depicts a system 400, in accordance with one embodiment. As an option, the present system 400 may be implemented in conjunction with features from any other embodiment listed herein, such as those described with reference to the other FIGS. Of course, however, such system 400 and others presented herein may be used in various applications and/or in permutations which may or may not be specifically described in the illustrative embodiments listed herein. Further, the system 400 presented herein may be used in any desired environment.

System 400 includes inventors 402 that generate ideas and information 404 associated new inventions. A plurality of evaluation bots 406 may be caused to evaluate the information to determine a course of action to follow to potentially protect intellectual property rights of the new inventions detailed by the information. An output 408 of the evaluation bots, which is based on the analysis, may include and/or be used to calculate scores for factors identified during the evaluations of the information, e.g., see real problem (0˜9), Business value (0˜9), etc. Techniques for calculating these scores are described elsewhere herein, e.g., see method 200. Furthermore, a total novelty score may be determined, based on the calculated scores, e.g., see Total.

Evaluation performed by the evaluation bots promotes streamlined bias free determinations of a novelty of new inventions, e.g., see logical flow 410, while feedback is incorporated into a process of ongoingly tuning and thereby increasing efficiencies of the evaluation bots, e.g., see logical flow 412.

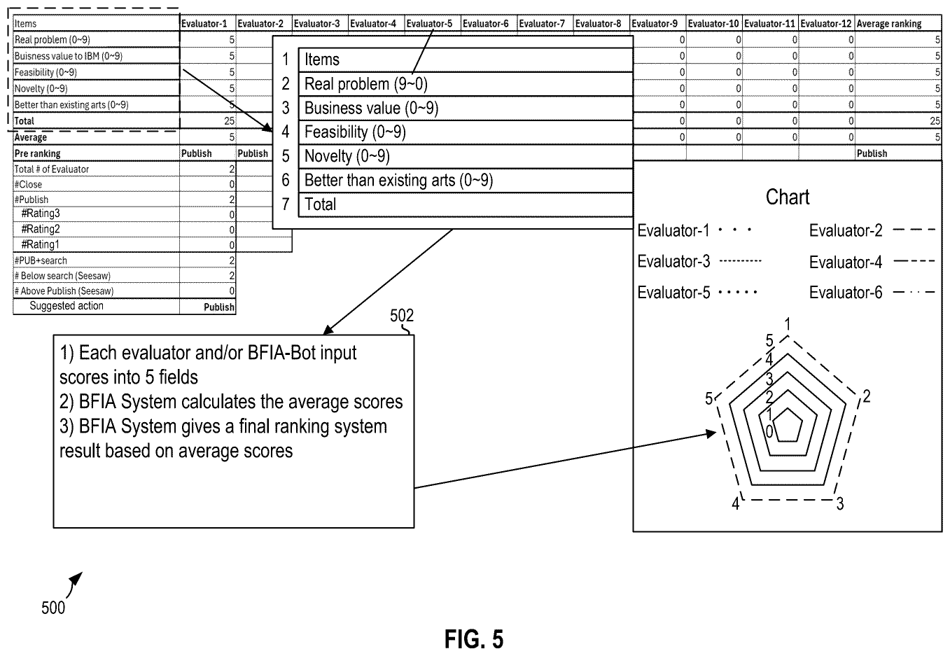

FIG. 5 depicts a table 500, in accordance with one embodiment. As an option, the present table 500 may be implemented in conjunction with features from any other embodiment listed herein, such as those described with reference to the other FIGS. Of course, however, such table 500 and others presented herein may be used in various applications and/or in permutations which may or may not be specifically described in the illustrative embodiments listed herein. Further, the table 500 presented herein may be used in any desired environment.

The table 500 includes information associated with evaluations performed by a plurality of different evaluation bots (see Evaluator-1, Evaluator-2, Evaluator-3, etc.) on information about a new invention. More specifically, the evaluator bots are configured to evaluate the information and output calculated scores and/or information that may be used to calculate scores for factors. In some approaches, these factors may be factors identified during the evaluations of the information about the first new invention, while in some other approaches, at least some of the factors are predetermined. In the present example, each of the evaluator bots is configured to calculate and input the scores into five fields, e.g., see first step of the operation steps 502. For example, for a plurality of items of information evaluated, the evaluation bots calculate scores for factors including real problem, business value, feasibility, novelty, and better than existing arts, while a total of these scores, e.g., see “Total”, may be calculated and thereafter used to determine a total novelty score. In some approaches, a graphical representation of the total novelty score (for each of the evaluator bots) may be generated and output to a display of a user device, e.g., see Chart.

In a second step of the operation steps 502, an average of the scores of the different evaluation bots is calculated, e.g., see Average, which may serve as a total novelty score of the new invention being evaluated. This total novelty score may be used to determine (using determination techniques detailed in method 200) a suggested action, e.g., see #Close, #Publish, #Rating3, etc.

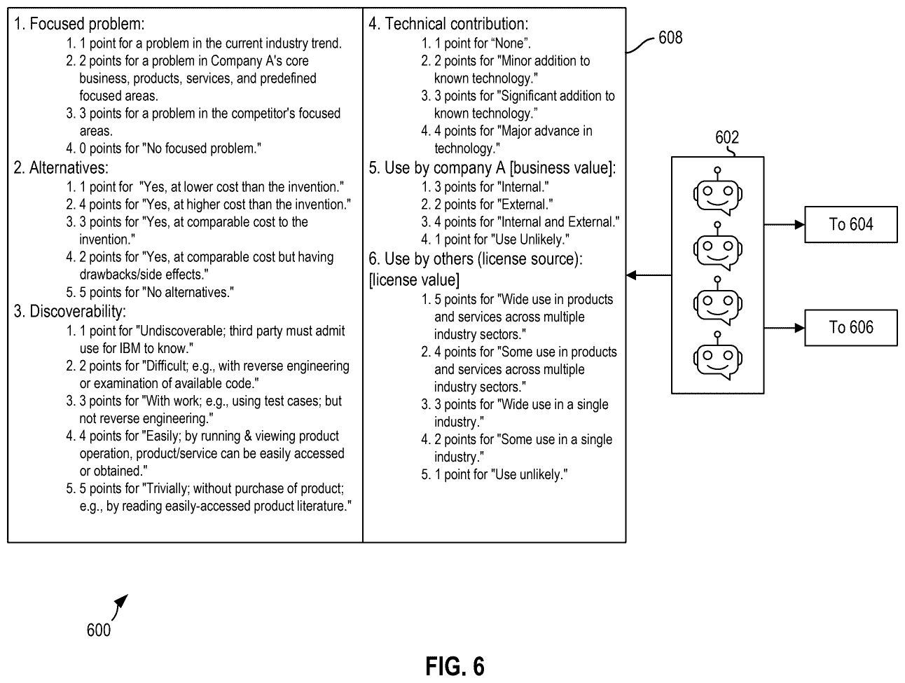

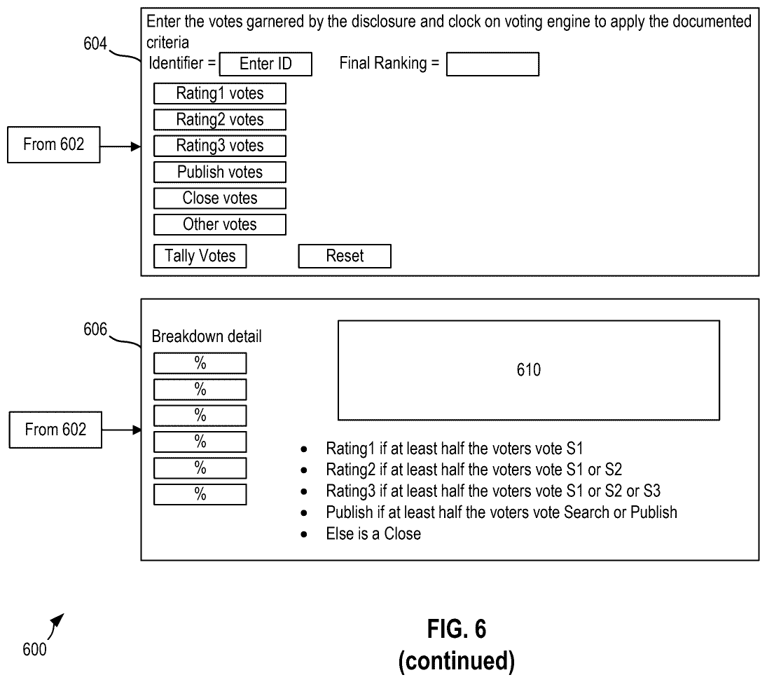

FIG. 6 depicts an architecture 600 of possible parameters and points used by evaluation bots for evaluating and ranking a new invention, in accordance with one embodiment. As an option, the present architecture 600 may be implemented in conjunction with features from any other embodiment listed herein, such as those described with reference to the other FIGS. Of course, however, such architecture 600 and others presented herein may be used in various applications and/or in permutations which may or may not be specifically described in the illustrative embodiments listed herein. Further, the architecture 600 presented herein may be used in any desired environment.

It may be prefaced that bots 602 illustrated in FIG. 6 may be used to operate within the architecture 600 to perform an evaluation of information about at least one new invention. Such bots may introduce several new features and novelties that set the bots apart from traditional innovation evaluation techniques. These bots therefore address critical challenges in the current landscape and elevate the efficiency, objectivity, and adaptability of the innovation review process. For example, the evaluation bots enable HCI-driven criteria adaptation by, in some approaches, incorporating insights from HCI analysis to dynamically adapt evaluation criteria. This adaptive approach ensures that the AI-driven criteria evolve based on feedback, promoting a collaborative and continuously improving evaluation framework. Bias detection and mitigation is also enabled by operations described herein as the bots integrate advanced algorithms for detecting and mitigating biases in innovation evaluations. Specifically, to achieve this, the evaluation bots are caused to leverage HCI patterns and machine learning to actively identify potential biases introduced by human evaluators and takes corrective measures, ensuring fair and unbiased assessments.

The evaluation bots furthermore harness generative AI capabilities for delivering a comprehensive analysis of inventions. More specifically, the evaluation bots employ generative AI models for automated text summarization, semantic analysis, and language translation. This comprehensive approach enhances the depth and accuracy of the analysis, allowing for a thorough examination of innovation disclosures and related materials. Automated drafting assistance is another feature that may be harnessed by the evaluation bots. The evaluation bots go beyond evaluation by providing automated drafting assistance for innovation applications, in some approaches. This drafting assistance is offered as the evaluation bots suggest language while ensuring compliance with legal standards. The application process is thereby streamlined, saving time for inventors and legal professionals. Real-time adaptation to industry trends is also enabled as a result of the scalability of the techniques described herein. Infrastructure of techniques described herein exhibit real-time adaptation to emerging industry trends. Through continuous monitoring of HCI patterns and keyword analysis, the evaluation bots remain agile and responsive, ensuring an evaluation criteria remains aligned with the dynamic landscape of technological advancements.

The bots are also optionally deployable with a user-friendly interface and feedback loop. More specifically, the evaluation bots feature user-friendly interface(s) that allow users to input innovation disclosures, view assessment results, and provide feedback. This interactive design fosters a feedback loop, enabling users to contribute to a system's improvement and ensures a user-centric approach to refining innovation assessment via feedback.

With continued reference to FIG. 6, the architecture 600 includes outputs 608 of the bots that includes score values (e.g., see 1 point, 4 points, etc., for different sub-factors of each factor) for factors (e.g., see focused problem, alternatives, discoverability, etc.) identified during the evaluations of the information about a first new invention. Although the outputs 608 are shown to include score values for different score values, in some other approaches, the outputs 608 may alternatively include information that details the findings of the evaluation performed by the bots, and the information may be used to calculate scores for the factors (using the calculation techniques described elsewhere herein).

Furthermore, a first window 604 of the architecture illustrates, according to one approach, information that may be output by the bots, and used to calculate scores for factors identified during the evaluations of the information about the first new invention and/or used to determine a total novelty score for the first new invention. For example, this information may include voting information for votes performed by the bots, e.g., see Rating1 votes, Rating2 votes, etc., as well as GUI features for using the information, e.g., see Tally Votes and Reset.

A second window 606 of the architecture further illustrates, according to one approach, information that may be output by the bots. For example, this information may include a statistical breakdown of votes for different potential scores and/or potential total novelty scores and/or suggested actions, e.g., see %. In some approaches, at least some of this information may be input into a predetermined balancing engine 610, e.g., via a drag and drop GUI feature, to calculate different potential scores and/or determine potential total novelty scores and/or determine suggested actions.

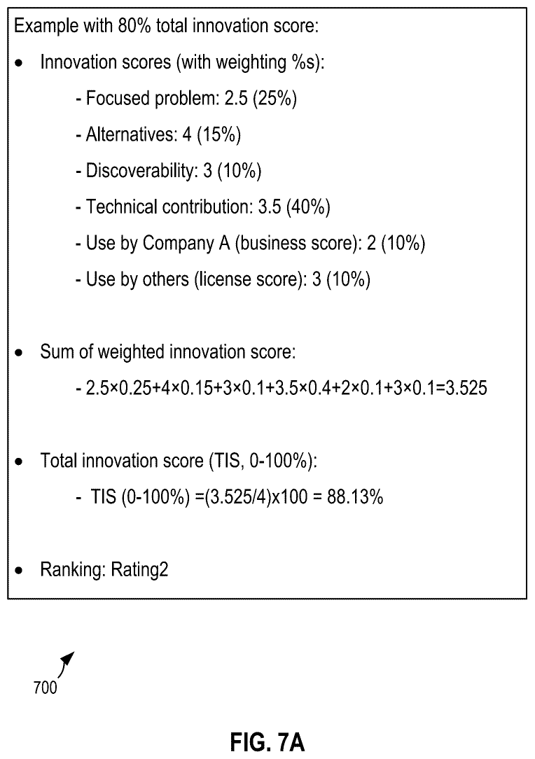

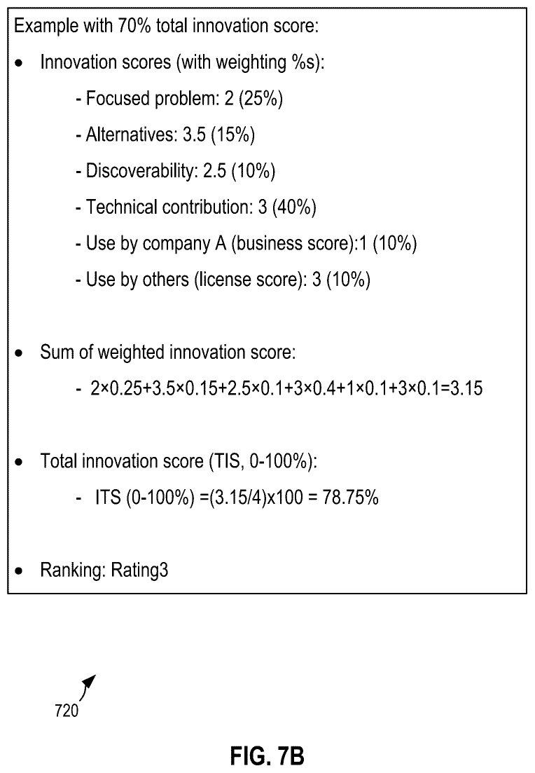

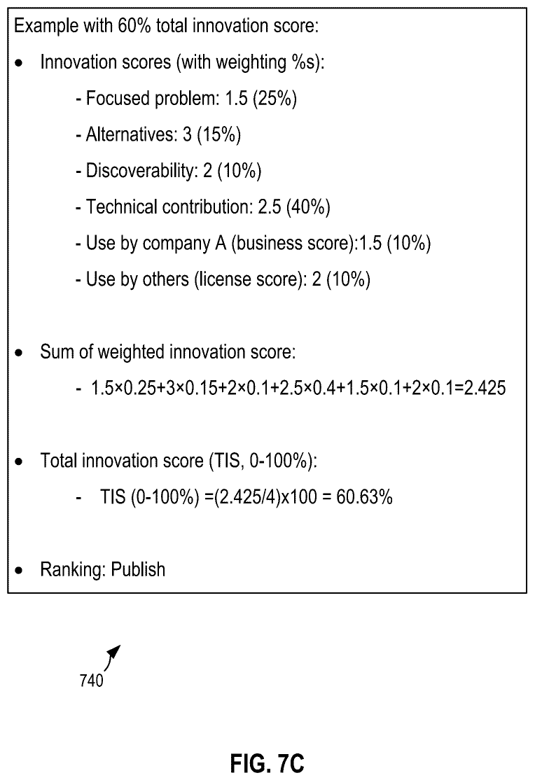

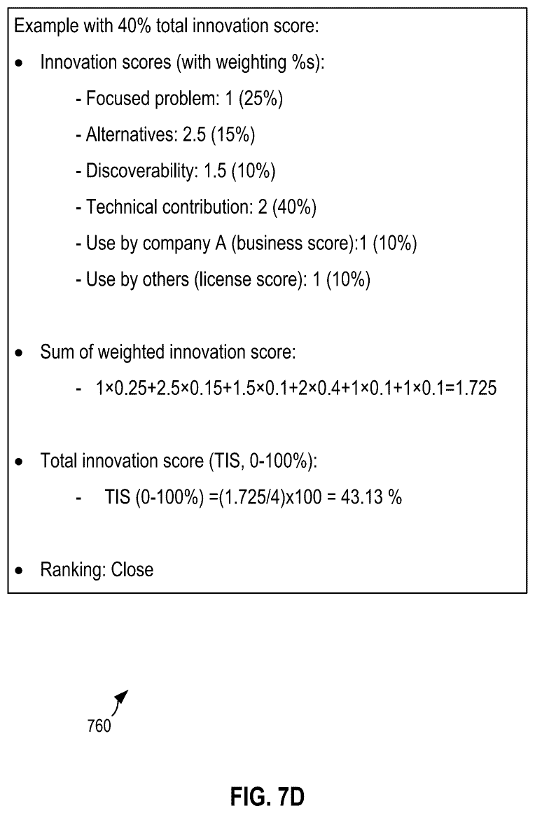

FIGS. 7A-7D depict evaluation reports 700, 720, 740 and 760 of new inventions, in accordance with several embodiments. As an option, the present evaluation reports 700, 720, 740 and 760 may be implemented in conjunction with features from any other embodiment listed herein, such as those described with reference to the other FIGS. Of course, however, such evaluation report 700, 720, 740 and 760 and others presented herein may be used in various applications and/or in permutations which may or may not be specifically described in the illustrative embodiments listed herein. Further, the evaluations reports 700, 720, 740 and 760 presented herein may be used in any desired environment.

Referring first to FIG. 7A, evaluation report 700 illustrates a case in which a total novelty score (referred to in FIGS. 7A-7D as “total innovation score” and “TIS”) is represented as a percentage, e.g., see 43.13%. This TIS is based on a plurality of different scores determined by evaluation bots and/or from information output by evaluation bots, e.g., see Innovation scores. The TIS is correlated to a suggested action associated with a first predetermined range of values that includes 43.13%, e.g., see suggested action “Close” the new invention.

Referring first to FIG. 7A, evaluation report 700 illustrates a case in which a total novelty score (referred to in FIGS. 7A-7D as “total innovation score” and “TIS”) is represented as a percentage, e.g., see 88.13%. This TIS is based on a plurality of different scores determined by evaluation bots and/or from information output by evaluation bots, e.g., see Innovation scores. The TIS is correlated to a suggested action associated with a predetermined range of values that includes 88.13%, e.g., see suggested action “Ranking2” for the new invention.

Referring next to FIG. 7B, evaluation report 720 illustrates a case in which a total novelty score (referred to in FIGS. 7A-7D as “total innovation score” and “TIS”) is represented as a percentage, e.g., see 78.75%. This TIS is based on a plurality of different scores determined by evaluation bots and/or from information output by evaluation bots, e.g., see Innovation scores. The TIS is correlated to a suggested action associated with a predetermined range of values that includes 78.75%, e.g., see suggested action “Ranking3” for the new invention.

Referring next to FIG. 7C, evaluation report 740 illustrates a case in which a total novelty score (referred to in FIGS. 7A-7D as “total innovation score” and “TIS”) is represented as a percentage, e.g., see 60.63%. This TIS is based on a plurality of different scores determined by evaluation bots and/or from information output by evaluation bots, e.g., see Innovation scores. The TIS is correlated to a suggested action associated with a predetermined range of values that includes 60.63%, e.g., see suggested action “Publish” for the new invention.

Referring lastly to FIG. 7D, evaluation report 760 illustrates a case in which a total novelty score (referred to in FIGS. 7A-7D as “total innovation score” and “TIS”) is represented as a percentage, e.g., see 43.13%. This TIS is based on a plurality of different scores determined by evaluation bots and/or from information output by evaluation bots, e.g., see Innovation scores. The TIS is correlated to a suggested action associated with a predetermined range of values that includes 43.13%, e.g., see suggested action to “Close” the new invention.

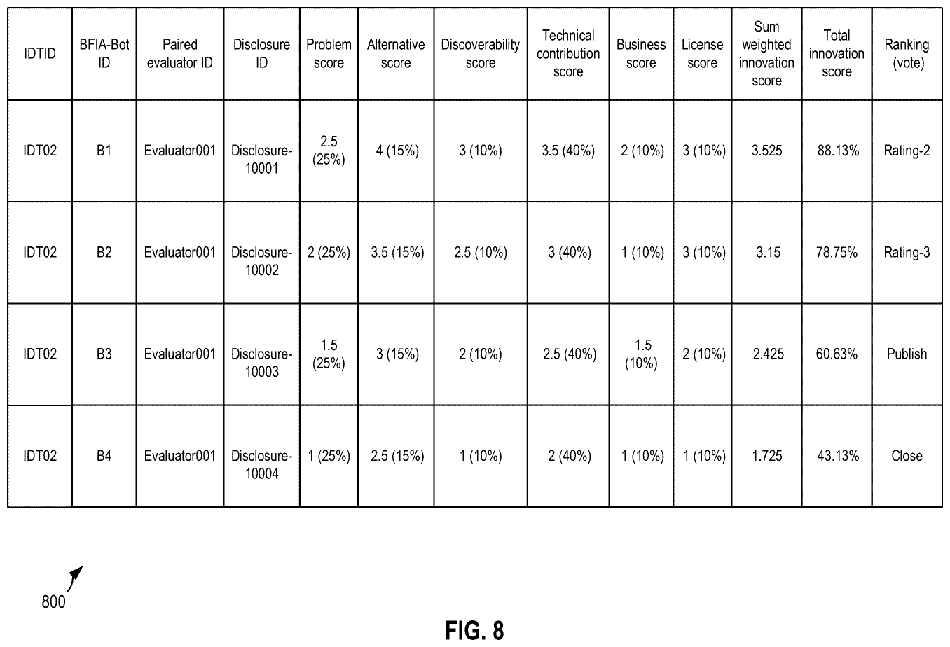

FIG. 8 depicts a table 800, in accordance with one embodiment. As an option, the present table 800 may be implemented in conjunction with features from any other embodiment listed herein, such as those described with reference to the other FIGS. Of course, however, such table 800 and others presented herein may be used in various applications and/or in permutations which may or may not be specifically described in the illustrative embodiments listed herein. Further, the table 800 presented herein may be used in any desired environment.

Table 800 includes information detailing evaluations performed by evaluation bots, e.g., see B1, B2, B3, etc., for a plurality of different new inventions, e.g., see Disclosure-10001, Disclosure-10002, Disclosure-10003, etc. Different scores may be calculated for different factors, e.g., see Problem score, Alternative score, etc., and used to determine a total novelty score (referred to in FIG. 6 as a “Total innovation score”) for the evaluated new invention. The total novelty score may be correlated to a suggested action, e.g., see Ranking (vote), using techniques described elsewhere herein.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
causing a plurality of evaluation bots to evaluate information about a first new invention, wherein the evaluation bots are configured to identify and exclude sub-portions of the information during the evaluations, wherein the sub-portions of the information are based on human opinion;
using an output of the evaluation bots to calculate scores for factors identified during the evaluations of the information about the first new invention;
determining, based on the calculated scores, a total novelty score for the first new invention;
correlating the total novelty score to a suggested action, wherein the suggested action corresponds to a course of action to follow with respect to securing intellectual property rights of the first new invention; and
displaying the suggested action on a display of a user device.

2. The method of claim 1, wherein the causing the plurality of evaluation bots to evaluate information about the first new invention includes: instructing the evaluation bots to scan the information about the first new invention for identifying the factors, wherein the factors are selected from the group consisting of: a focused problem, listed alternative methods for achieving an outcome of the first new invention, a discoverability of the first new invention, technical contributions of the first new invention, a business value of the first new invention, and a license value of the first new invention.

3. The method of claim 1, wherein the suggested action is selected from the group consisting of: searching for prior art and writing a patent application for the first new invention according to a first predetermined set of guidelines, searching for prior art and writing a patent application for the first new invention according to a second predetermined set of guidelines, searching for prior art and writing a patent application for the first new invention according to a third predetermined set of guidelines, publishing a public article about the first new invention, and discarding the first new invention.

4. The method of claim 1, further comprising:
determining service settings for the evaluation bots to apply to evaluate the information about the first new invention;
defining criteria for the evaluation bots to apply to evaluate the information about the first new invention,
wherein causing the plurality of evaluation bots to evaluate the information about the first new invention comprises: instructing the evaluation bots to adhere to the service settings and the criteria while evaluating the information about the first new invention; and
using a training set of data to train the evaluation bots, wherein the evaluation bots are caused to evaluate the information about the first new invention in response to a determination that a predetermined threshold of accuracy has been achieved by the evaluation bots as a result of the training.

5. The method of claim 4,
wherein the service settings are selected from the group consisting of: permissible search engines that the evaluation bots are permitted to use to evaluate the information about the first new invention, review discussion boards and/or channels that the evaluation bots are permitted to use to evaluate the information about the first new invention, and evaluator academic histories that the evaluation bots are permitted to consider to evaluate the information about the first new invention, and
wherein the criteria is selected from the group consisting of: selected parameters and weights to scan the information about the first new invention with, a review board domain to use for obtaining the information about the first new invention, and ranking rules for the evaluation bots to apply to evaluate the information about the first new invention.

6. The method of claim 4, wherein the suggested action includes writing and filing a patent application for the first new invention, and further comprising:
receiving feedback about the suggested action, wherein the feedback details a revenue generated on a patent granted based on filing the patent application for the first new invention;
determining, based on the feedback received, an adjustment for the criteria to increase an accuracy of the evaluation bots; and
performing the adjustments to the criteria.

7. The method of claim 4, wherein the using the training set of data to train the evaluation bots comprises:
accessing a management system to which information about new inventions is stored, wherein the information about the first new invention is obtained from the management system;
collecting a plurality of training samples from the information stored within the management system, wherein the plurality of training samples are vetted and aggregated to form the training set of data;
causing the evaluation bots to consume the training set of data and output novelty estimations for new inventions that the training set of data is based on;
determining an accuracy of the novelty estimations; and
in response to a determination that the determined accuracy exceeds a predetermined threshold of accuracy, providing reward based feedback to the evaluation bots.

8. The method of claim 1, wherein a first of the evaluation bots is trained to identify information based on human opinion, and further comprising:
defining a bot data structure with related algorithms for tracking information about a plurality of new inventions over time, wherein the plurality of new inventions includes the first new invention; and
defining an installable plugin or stand-alone application that is configured to collaborate with a graphical user interface (GUI) and a predetermined innovation management system that serves as an extension for the evaluation bots.

9. A computer program product comprising:
one or more computer-readable storage media; and
program instructions stored on the one or more storage media to perform operations comprising:
causing a plurality of evaluation bots to evaluate information about a first new invention, wherein the evaluation bots are configured to identify and exclude sub-portions of the information during the evaluations, wherein the sub-portions of the information are based on human opinion;
using an output of the evaluation bots to calculate scores for factors identified during the evaluations of the information about the first new invention;
determining, based on the calculated scores, a total novelty score for the first new invention;
correlating the total novelty score to a suggested action, wherein the suggested action corresponds to a course of action to follow with respect to securing intellectual property rights of the first new invention; and
displaying the suggested action on a display of a user device.

10. The computer program product of claim 9, wherein the causing the plurality of evaluation bots to evaluate information about the first new invention includes: instructing the evaluation bots to scan the information about the first new invention for identifying the factors, wherein the factors are selected from the group consisting of: a focused problem, listed alternative methods for achieving an outcome of the first new invention, a discoverability of the first new invention, technical contributions of the first new invention, a business value of the first new invention, and a license value of the first new invention.

11. The computer program product of claim 9, wherein the suggested action is selected from the group consisting of: searching for prior art and writing a patent application for the first new invention according to a first predetermined set of guidelines, searching for prior art and writing a patent application for the first new invention according to a second predetermined set of guidelines, searching for prior art and writing a patent application for the first new invention according to a third predetermined set of guidelines, publishing a public article about the first new invention, and discarding the first new invention.

12. The computer program product of claim 9, wherein the operations further comprise:
determining service settings for the evaluation bots to apply to evaluate the information about the first new invention;
defining criteria for the evaluation bots to apply to evaluate the information about the first new invention,
wherein causing the plurality of evaluation bots to evaluate the information about the first new invention comprises: instructing the evaluation bots to adhere to the service settings and the criteria while evaluating the information about the first new invention; and
using a training set of data to train the evaluation bots, wherein the evaluation bots are caused to evaluate the information about the first new invention in response to a determination that a predetermined threshold of accuracy has been achieved by the evaluation bots as a result of the training.

13. The computer program product of claim 12,
wherein the service settings are selected from the group consisting of: permissible search engines that the evaluation bots are permitted to use to evaluate the information about the first new invention, review discussion boards and/or channels that the evaluation bots are permitted to use to evaluate the information about the first new invention, and evaluator academic histories that the evaluation bots are permitted to consider to evaluate the information about the first new invention, and
wherein the criteria is selected from the group consisting of: selected parameters and weights to scan the information about the first new invention with, a review board domain to use for obtaining the information about the first new invention, and ranking rules for the evaluation bots to apply to evaluate the information about the first new invention.

14. The computer program product of claim 12, wherein the suggested action includes writing and filing a patent application for the first new invention, wherein the operations further comprise:
receiving feedback about the suggested action, wherein the feedback corresponds to a revenue generated on a patent granted based on filing the patent application for the first new invention;
determining, based on the feedback received, an adjustment for the criteria to increase an accuracy of the evaluation bots; and
performing the adjustments to the criteria.

15. The computer program product of claim 12, wherein the using the training set of data to train the evaluation bots comprises:
accessing a management system to which information about new inventions is stored, wherein the information about the first new invention is obtained from the management system;
collecting a plurality of training samples from the information stored within the management system, wherein the plurality of training samples are vetted and aggregated to form the training set of data;
causing the evaluation bots to consume the training set of data and output novelty estimations for new inventions that the training set of data is based on;
determining an accuracy of the novelty estimations; and
in response to a determination that the determined accuracy exceeds a predetermined threshold of accuracy, providing reward based feedback to the evaluation bots.

16. The computer program product of claim 9, wherein a first of the evaluation bots is trained to identify information based on human opinion, and wherein the operations further comprise:
defining a bot data structure with related algorithms for tracking information about a plurality of new inventions over time, wherein the plurality of new inventions includes the first new invention; and
defining an installable plugin or stand-alone application that is configured to collaborate with a graphical user interface (GUI) and a predetermined innovation management system that serves as an extension for the evaluation bots.

17. A computer system comprising:
a processor set;
one or more computer-readable storage media; and
program instructions stored on the one or more storage media to cause the processor set to perform operations comprising:
causing a plurality of evaluation bots to evaluate information about a first new invention, wherein the evaluation bots are configured to identify and exclude sub-portions of the information during the evaluations, wherein the sub-portions of the information are based on human opinion;
using an output of the evaluation bots to calculate scores for factors identified during the evaluations of the information about the first new invention;
determining, based on the calculated scores, a total novelty score for the first new invention;
correlating the total novelty score to a suggested action, wherein the suggested action corresponds to a course of action to follow with respect to securing intellectual property rights of the first new invention; and
displaying the suggested action on a display of a user device.

18. The computer system of claim 17, wherein the causing the plurality of evaluation bots to evaluate information about the first new invention includes: instructing the evaluation bots to scan the information about the first new invention for identifying the factors, wherein the factors are selected from the group consisting of: a focused problem, listed alternative methods for achieving an outcome of the first new invention, a discoverability of the first new invention, technical contributions of the first new invention, a business value of the first new invention, and a license value of the first new invention.

19. The computer system of claim 17, wherein the operations further comprise:
determining service settings for the evaluation bots to apply to evaluate the information about the first new invention;
defining criteria for the evaluation bots to apply to evaluate the information about the first new invention,
wherein causing the plurality of evaluation bots to evaluate the information about the first new invention comprises: instructing the evaluation bots to adhere to the service settings and the criteria while evaluating the information about the first new invention; and
using a training set of data to train the evaluation bots, wherein the evaluation bots are caused to evaluate the information about the first new invention in response to a determination that a predetermined threshold of accuracy has been achieved by the evaluation bots as a result of the training.

20. The computer system of claim 17, wherein a first of the evaluation bots is trained to identify information based on human opinion, and wherein the operations further comprise:
defining a bot data structure with related algorithms for tracking information about a plurality of new inventions over time, wherein the plurality of new inventions includes the first new invention; and
defining an installable plugin or stand-alone application that is configured to collaborate with a graphical user interface (GUI) and a predetermined innovation management system that serves as an extension for the evaluation bots.
